(19) United States
(12) Patent Application Publication
(10) Pub. No.: US 2010/0314240 A1
(43) Pub. Date: Dec. 16, 2010

(54) Process of extracting aromatic compounds from plants using bromomethane as a solvent

(76) Inventors: Kai Lin, Xiamen (CN); Hongliang Lu, Xiamen (CN); Pengfei Ma, Xiamen (CN)

Correspondence Address: SAM CHEN, 7F-1, 293, ROOSEVELT ROAD, SEC 3, TAIPEI, TW

(21) Appl. No.: 12/571,419

(22) Filed: Sep. 30, 2009

(30) Foreign Application Priority Data
Jun. 15, 2009 (CN) 200910111997.2

(51) Int. Cl. B01D 3/34

(52) U.S. Cl. 203/67

(57) ABSTRACT

An extracting process includes adding 30 g of honeysuckle into a first flask in a cooling bath; adding 150 g bromomethane as a solvent into the first flask and sealing the first flask so that the solvent dissolves the honeysuckle powder to form a solution after about 15 hours; removing the first flask; and connecting the first flask to a first second flask and connecting a third flask to a last second flask wherein the second flasks are interconnected, each second flask is placed in another cooling bath, the third flask is placed in still another cooling bath, the solution evaporates to flow the vaporized aromatic compounds thereof to the second flasks for absorption by aromatic compounds absorbent fluid contained in each second flask, and the vaporized bromomethane of the solution reaches the third flask to be cooled and collected in the form of liquid.

### BACKGROUND OF THE INVENTION

1. Field of Invention

The invention relates to extractions and more particularly to a process of extracting aromatic compounds from odorous plants (e.g., honeysuckle, chrysanthemum, licorice, etc.) using bromomethane as a solvent in conditions of low temperature (e.g., in a range of −10° C. to 0° C.) and standard atmospheric pressure with the bromomethane being collected at a low temperature (e.g., in a range of −20° C. to 0° C.) for recycle at the end of the process.

2. Description of Related Art

Extractions, distillations, etc. have been used for obtaining fragrant oils and compounds from odorous raw materials (e.g., herbs). These conventional processes are disadvantageous due to low efficiency, high energy consumption, and high solvent consumption.

Recently, a number of techniques such as SBE (semi-biological extraction), MAE (microwave accelerated extraction), supercritical fluid extraction, ultrasonic extraction, and centrifugal separation have been devised. Solvents such as alcohol, water, liquid carbon dioxide, petroleum ether, methyl dichloride, and ethyl acetate are typically used in the extraction.

However, a number of disadvantages have been found in above typical processes. For example, obtained aromatic compounds have been damaged in the process due to high temperature, high atmospheric pressure, and toxic compounds of solvent. To the worse, the obtained aromatic compounds may contain toxic compounds which are very difficult of removing. Thus, a need for improvement exists.

### SUMMARY OF THE INVENTION

It is therefore one object of the invention to provide a process of extracting extracting aromatic compounds from odorous plants (e.g., honeysuckle, chrysanthemum, or licorice) using bromomethane as a solvent in conditions of low temperature (e.g., in a range of −10° C. to 0° C.) and standard atmospheric pressure with the bromomethane being collected at a low temperature (e.g., in a range of −20° C. to 0° C.) for recycle at the end of the process.

The above and other objects, features and advantages of the invention will become apparent from the following detailed description taken with the accompanying drawings.

### BRIEF DESCRIPTION OF THE DRAWINGS

FIG. 1 is a side elevation of a bath with a first flask disposed therein in which coolant is contained in the bath and the first flask contains a raw material dissolved by bromomethane as a solvent showing first and second steps of an extracting process according to the invention;

FIG. 2 is a side elevation of an arrangement of the first flask, a plurality of second flasks for collecting aromatic compounds, and a third flask for collecting bromomethane to be recycled showing third, fourth, and fifth steps of the extracting process according to the invention; and

FIG. 3 is a flowchart depicting the extracting process for obtaining aromatic compounds according to the invention.

### DETAILED DESCRIPTION OF THE INVENTION

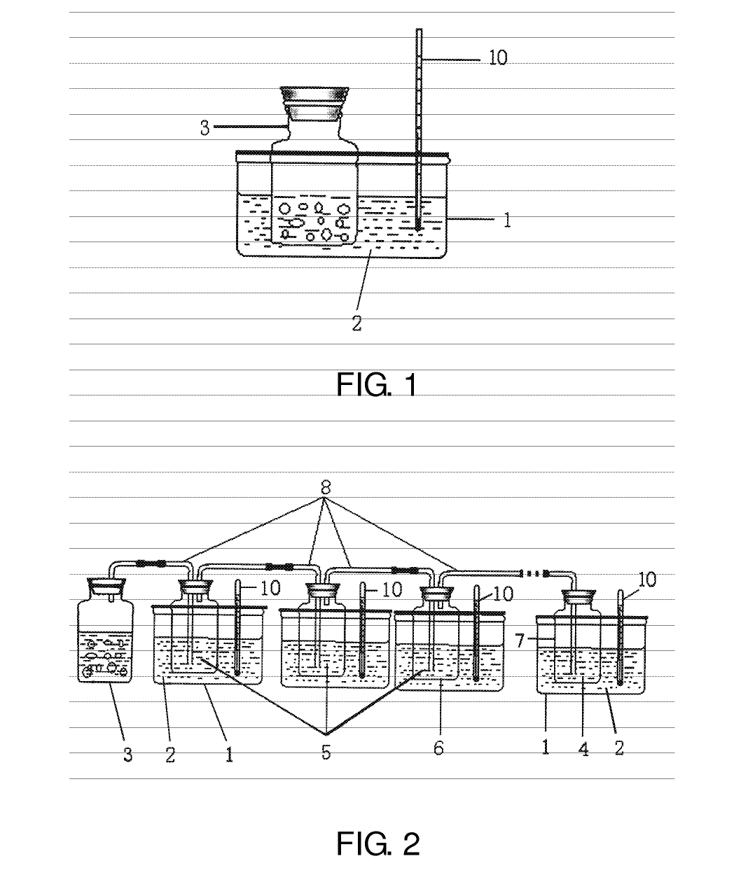

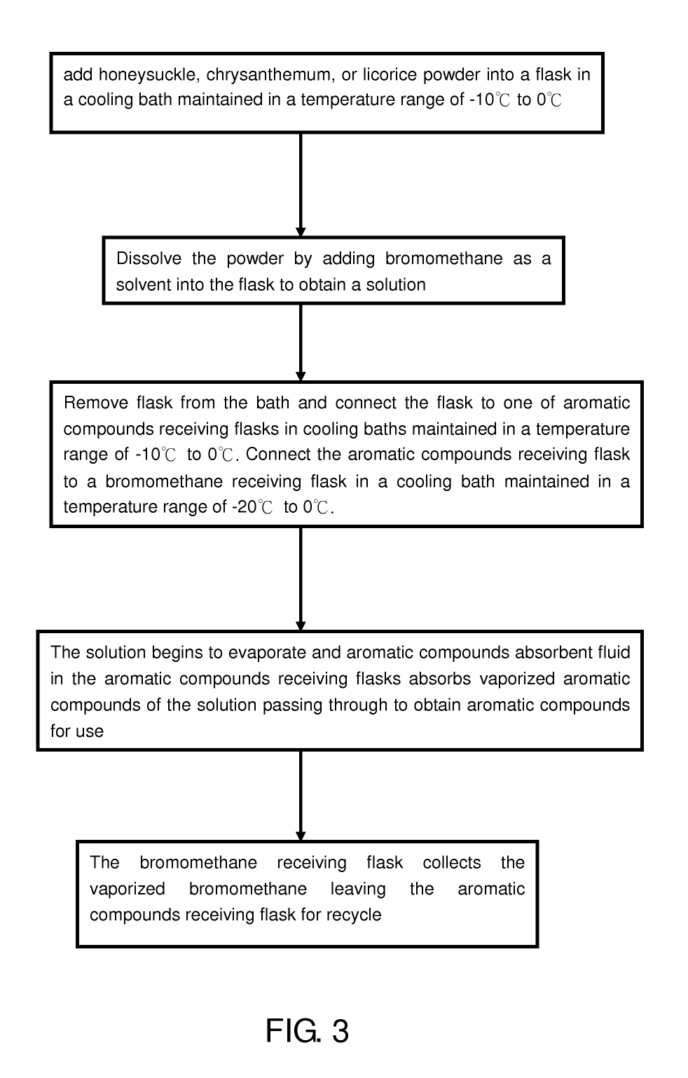

Referring to FIGS. 1 to 3, an extracting process in accordance with the invention is illustrated.

### Embodiment I

As shown in FIG. 1, add about 30 g of honeysuckle powder into a first flask 3 in a bath 1. A quantity of coolant 2 is contained in the bath 1. A thermometer 10 is mounted in the bath 1. The bath 1 is cooled by the coolant 2. The bath 1 is maintained in a temperature range of −10° C. to 0° C. and is under standard atmospheric pressure. Next, add about 150 g of bromomethane (CH₃Br) as a solvent into the first flask 3 and seal the first flask 3. The solvent begins to dissolve the honeysuckle powder. A homogeneous solution is formed in the first flask 3 after about 15 hours. These are first and second steps of the process. Note that a person should watch the thermometer 10 regularly since the temperature of the bath 1 may increase as the first and second steps evolve. Further, the person should add coolant 2 into the bath 1 at any time in order to maintain the bath 1 at the temperature range of −10° C. to 0° C.

As shown in FIG. 2, the first flask 3 has been removed from the bath 1 shown in FIG. 1. Connect the first flask 3 to a first one of a plurality of (e.g., three) second flasks 6 by piping 8. The second flasks 6 are also connected together by piping 8. Each second flask 6 is placed in a bath 1 containing coolant 2. The baths 1 are maintained in a temperature range of −10° C. to 0° C. Each second flask 6 contains a quantity of aromatic compounds absorbent fluid 5. A thermometer 10 is mounted in each bath 1. The first flask 3 and the baths 1 are placed in a condition of room temperature (e.g., in a temperature range of 20° C. to 25° C.) and are under standard atmospheric pressure. Hence, the solution in the first flask 3 quickly evaporates by absorbing heat. The vaporized aromatic compounds of the solution and the vaporized bromomethane pass through the second flasks 6 sequentially. The vaporized aromatic compounds of the solution, based on different boiling points of its components, are absorbed by the aromatic compounds absorbent fluid 5. The collected aromatic compounds can be used as essential oils, perfumery, medicinal, or the like. These are third and fourth steps of the process. Note that a person should watch the thermometer 10 regularly since the temperature of each bath 1 may increase as the third and fourth steps evolve. Further, the person should add coolant 2 into any baths 1 at any time in order to maintain the baths 1 at the temperature range of −10° C. to 0° C.

The vaporized bromomethane of the solution finally reaches a third flask 7 which is connected to the last one of the second flasks 6 by piping 8. The third flask 7 is placed in a bath 1 with a quantity of coolant 2 contained therein. A thermometer 10 is mounted in the bath 1. The bath 1 is maintained in a predetermined low temperature (e.g., in a temperature range of −20° C. to 0° C.) and is under standard atmospheric pressure. The vaporized bromomethane of the solution is cooled again to be collected in the third flask 7 in the form of liquid 4. The liquid bromomethane 4 can be recycled for future use. This is the fifth step of the process.

### Embodiment II

As shown in FIG. 1, add about 30 g of chrysanthemum powder into a first flask 3 in a bath 1. A quantity of coolant 2 is contained in the bath 1. A thermometer 10 is mounted in the bath 1. The bath 1 is cooled by the coolant 2. The bath 1 is maintained in a temperature range of −10° C. to 0° C. and is under standard atmospheric pressure. Next, add about 130 g of bromomethane (CH₃Br) as a solvent into the first flask 3 and seal the first flask 3. The solvent begins to dissolve the chrysanthemum powder. A homogeneous solution is formed in the first flask 3 after about 10 hours. These are first and second steps of the process. Note that a person should watch the thermometer 10 regularly since the temperature of the bath 1 may increase as the first and second steps evolve. Further, the person should add coolant 2 into the bath 1 at any time in order to maintain the bath 1 at the temperature range of −10° C. to 0° C.

As shown in FIG. 2, the first flask 3 has been removed from the bath 1 shown in FIG. 1. Connect the first flask 3 to a first one of a plurality of (e.g., three) second flasks 6 by piping 8. The second flasks 6 are also connected together by piping 8. Each second flask 6 is placed in a bath 1 containing coolant 2. The baths 1 are maintained in a temperature range of −10° C. to 0° C. Each second flask 6 contains a quantity of aromatic compounds absorbent fluid 5. A thermometer 10 is mounted in each bath 1. The first flask 3 and the baths 1 are placed in a condition of room temperature (e.g., in a temperature range of 20° C. to 25° C.) and are under standard atmospheric pressure. Hence, the solution in the first flask 3 quickly evaporates by absorbing heat. The vaporized aromatic compounds and the vaporized bromomethane of the solution pass through the second flasks 6 sequentially. The vaporized aromatic compounds of the solution, based on different boiling points of its components, are absorbed by the aromatic compounds absorbent fluid 5. The collected aromatic compounds can be used as essential oils, perfumery, medicinal, or the like. These are third and fourth steps of the process. Note that a person should watch the thermometer 10 regularly since the temperature of each bath 1 may increase as the third and fourth steps evolve. Further, the person should add coolant 2 into any baths 1 at any time in order to maintain the baths 1 at the temperature range of −10° C. to 0° C.

The vaporized bromomethane of the solution finally reaches a third flask 7 which is connected to the last one of the second flasks 6 by piping 8. The third flask 7 is placed in a bath 1 with a quantity of coolant 2 contained therein. A thermometer 10 is mounted in the bath 1. The bath 1 is maintained in a predetermined low temperature (e.g., in a temperature range of −20° C. to 0° C.) and is under standard atmospheric pressure. The vaporized bromomethane of the solution is cooled again to be collected in the third flask 7 in the form of liquid 4. The liquid bromomethane 4 can be recycled for future use. This is the fifth step of the process.

### Embodiment III

As shown in FIG. 1, add about 50 g of licorice powder into a first flask 3 in a bath 1. A quantity of coolant 2 is contained in the bath 1. A thermometer 10 is mounted in the bath 1. The bath 1 is cooled by the coolant 2. The bath 1 is maintained in a temperature range of −10° C. to 0° C. and is under standard atmospheric pressure. Next, add about 180 g of bromomethane (CH₃Br) as a solvent into the first flask 3 and seal the first flask 3. The solvent begins to dissolve the licorice powder. A homogeneous solution is formed in the first flask 3 after about 20 hours. These are first and second steps of the process. Note that a person should watch the thermometer 10 regularly since the temperature of the bath 1 may increase as the first and second steps evolve. Further, the person should add coolant 2 into the bath 1 at any time in order to maintain the bath 1 at the temperature range of −10° C. to 0° C.

As shown in FIG. 2, the first flask 3 has been removed from the bath 1 shown in FIG. 1. Connect the first flask 3 to a first one of a plurality of (e.g., three) second flasks 6 by piping 8. The second flasks 6 are also connected together by piping 8. Each second flask 6 is placed in a bath 1 containing coolant 2. The baths 1 are maintained in a temperature range of −10° C. to 0° C. Each second flask 6 contains a quantity of aromatic compounds absorbent fluid 5. A thermometer 10 is mounted in each bath 1. The first flask 3 and the baths 1 are placed in a condition of room temperature (e.g., in a temperature range of 20° C. to 25° C.) and are under standard atmospheric pressure. Hence, the solution in the first flask 3 quickly evaporates by absorbing heat. The vaporized aromatic compounds and the vaporized bromomethane of the solution pass through the second flasks 6 sequentially. The vaporized aromatic compounds of the solution, based on different boiling points of its compounds, are absorbed by the aromatic compounds absorbent fluid 5. The collected aromatic compounds can be used as essential oils, perfumery, medicinal, or the like. These are third and fourth steps of the process. Note that a person should watch the thermometer 10 regularly since the temperature of each bath 1 may increase as the third and fourth steps evolve. Further, the person should add coolant 2 into any baths 1 at any time in order to maintain the baths 1 at the temperature range of −10° C. to 0° C.

The vaporized bromomethane of the solution finally reaches a third flask 7 which is connected to the last one of the second flasks 6 by piping 8. The third flask 7 is placed in a bath 1 with a quantity of coolant 2 contained therein. A thermometer 10 is mounted in the bath 1. The bath 1 is maintained in a predetermined low temperature (e.g., in a temperature range of −20° C. to 0° C.) and is under standard atmospheric pressure. The vaporized bromomethane of the solution is cooled again to be collected in the third flask 7 in the form of liquid 4. The liquid bromomethane 4 can be recycled for future use. This is the fifth step of the process.

While the invention herein disclosed has been described by means of specific embodiments, numerous modifications and variations could be made thereto by those skilled in the art without departing from the scope and spirit of the invention set forth in the claims.

What is claimed is:

1. An extracting process comprising the steps of:
(a) adding a predetermined weight of a predetermined powder into a first flask in a first cooling bath maintained at a first predetermined temperature;
(b) adding a predetermined weight of bromomethane as a solvent into the first flask and sealing the first flask so that the solvent dissolves the predetermined powder to form a homogeneous solution after a predetermined period of time;
(c) removing the first flask from the first bath; and
(d) connecting the first flask to a first one of a plurality of second flasks containing a quantity of aromatic compounds absorbent fluid, interconnecting the second flasks, and connecting a third flask to the last one of the second flasks wherein each of the second flasks is placed in a second cooling bath maintained at the first predetermined temperature, the third flask is placed in a third cooling bath maintained at a second predetermined temperature, the solution evaporates to flow vaporized aromatic compounds thereof to the second flasks for absorption by the aromatic compounds absorbent fluid, and the vaporized bromomethane of the solution reaches the third flask to be condensed and collected therein.

2. The extracting process of claim 1, wherein the predetermined powder is honeysuckle and the predetermined weight thereof is 30 g, the first predetermined temperature is in a range of −10° C. to 0° C., the predetermined weight of bromomethane is 150 g, the predetermined period of time is 15 hours, and the second predetermined temperature is in a range of −20° C. to 0° C.

3. The extracting process of claim 1, wherein the predetermined powder is chrysanthemum and the predetermined weight thereof is 30 g, the first predetermined temperature is in a range of −10° C. to 0° C., the predetermined weight of bromomethane is 130 g, the predetermined period of time is 10 hours, and the second predetermined temperature is in a range of −20° C. to 0° C.

4. The extracting process of claim 1, wherein the predetermined powder is licorice and the predetermined weight thereof is 50 g, the first predetermined temperature is in a range of −10° C. to 0° C., the predetermined weight of bromomethane is 180 g, the predetermined period of time is 20 hours, and the second predetermined temperature is in a range of −20° C. to 0° C.
